(19) United States
(12) Patent Application Publication
(10) Pub. No.: US 2007/0029058 A1
(43) Pub. Date: Feb. 8, 2007

(54) Hanging structure for sunshade device

(75) Inventor: Yung-Ching Lin, Yongkang City (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Macauto Industrial Co., Ltd., Yongkang City (TW)

(21) Appl. No.: 11/196,682

(22) Filed: Aug. 3, 2005

(51) Int. Cl. B60J 1/20

(52) U.S. Cl. 160/370.22

(57) ABSTRACT

A hanging structure for sunshade device, comprising a hanging unit, an edge strip set, at least an elastic element, and at least a pin-joint element is disclosed. The hanging unit has a hanging member formed at its head and a tail piece formed at its end; the edge strip set has at least one slot; the elastic element is disposed between the edge strip set and the hanging unit; and the pin-joint element adjoins the hanging unit to the slot of edge strip set that allows the hanging unit to swing in the slot. When the sunshade device is folded, the hanging unit forms a first intersection angle with the horizontal line; when the sunshade device is unfolded, the hanging unit forms a second intersection angle with the horizontal line.

### BACKGROUND OF THE INVENTION

1. Field of the Invention

The present invention relates to a hanging structure for sunshade device, more particularly a kind of hanging structure that forms different hanging angles when the sunshade device is folded and unfolded.

2. Description of Related Art

People nowadays tend to spend more time indoor or inside a car and like to pull down the curtain installed on the window to shield off sunlight or lights, or block the sight of other people for the sake of sunblocking or privacy. Conventional sunshade device 10′ for vehicles as shown in FIG. 1 (a perspective view) and FIG. 2 (a diagram showing the sunshade in use) typically consists of a positioning barrel 20′ with a fold/unfold mechanism 21′ configured therein. The fold/unfold mechanism 21′ is secured to one side of a curtain 50′, while the other end of curtain 50′ is arranged with an edge strip 30′ with a pull hanger 40′ disposed thereon. Such sunshade device 10′ is mounted on a flat board 71′ at the bottom of the rear window of vehicle 70′, and a hanging bracket 60′ is mounted on the top of rear window or the rooftop of vehicle. When needed, the user can hold the pull hanger 40′ and pull it upward to unfold the curtain 50′ and hook the pull hanger 40′ onto the hanging bracket 60′. By the restoring force generated from the pull-back action of the fold/unfold mechanism 21′ against the curtain 50′, the tension produced thereof keeps the curtain 50′ in the state of unfolding. The conventional sunshade structure and technique are able to achieve the objective of folding and unfolding the curtain. But if its hanging surface is not a vertical or a leveled surface, the hanging bracket and the pull hanger will not form a straight line, but an intersection angle. At times when such angle is too demanding, the hanging will be made difficult.

### SUMMARY OF THE INVENTION

To address the drawback of prior art, the object of the present invention is to provide a hanging structure for sunshade device which allows convenient application on windows with a slope or in occasions where the hanging bracket is positioned at an angle, such as on the windshield or rear window of a car.

The present invention discloses a hanging structure for sunshade device, comprising at least a hanging unit with a hanging member formed at its head; an edge strip set connected to the free end of curtain and having at least one slot; an elastic element disposed between the edge strip set and the hanging unit; and at least a pin-joint element which joins the hanging unit to the slot of edge strip set. In light that the hanging unit is able to swing to a certain degree inside the slot of edge strip set, the hanging unit is laid flat when the curtain of sunshade device is folded, and springs up to form an inclined angle after the curtain is unfolded to facilitate its hooking to the hanging bracket on the window or rooftop of vehicle. When the curtain is folded again, the hanging unit returns to a fully reclined state.

The present invention further discloses a hanging structure for sunshade device wherein its edge strip set is further arranged with at least a handle to facilitate the folding and unfolding of sunshade curtain.

The present invention further discloses a hanging structure for sunshade device, wherein the hanging member at the head of its hanging unit is a hang hole or a hook that can engage the hanging bracket.

### BRIEF DESCRIPTION OF THE DRAWINGS

FIG. 1 is a perspective view of sunshade for vehicles of prior art;

FIG. 2 is the diagram of the sunshade in FIG. 1 in use;

FIG. 3 is a diagram showing the unfolding and folding of the sunshade device in an embodiment of the invention;

FIG. 4 is an exploded view of the major components of the hanging structure in an embodiment of the invention;

FIG. 5 is a diagram of the hanging structure in FIG. 4 in the state of assembly;

FIG. 6 is a diagram of an embodiment of the invention in use;

FIG. 7 is a diagram showing the hanging unit and pin-joint element in another embodiment of the invention; and

FIG. 8 is a diagram showing the hanging member with a hook in an embodiment of the invention.

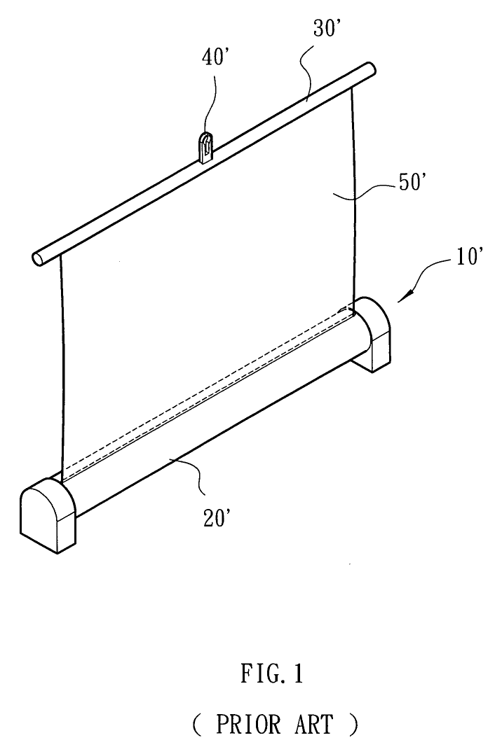

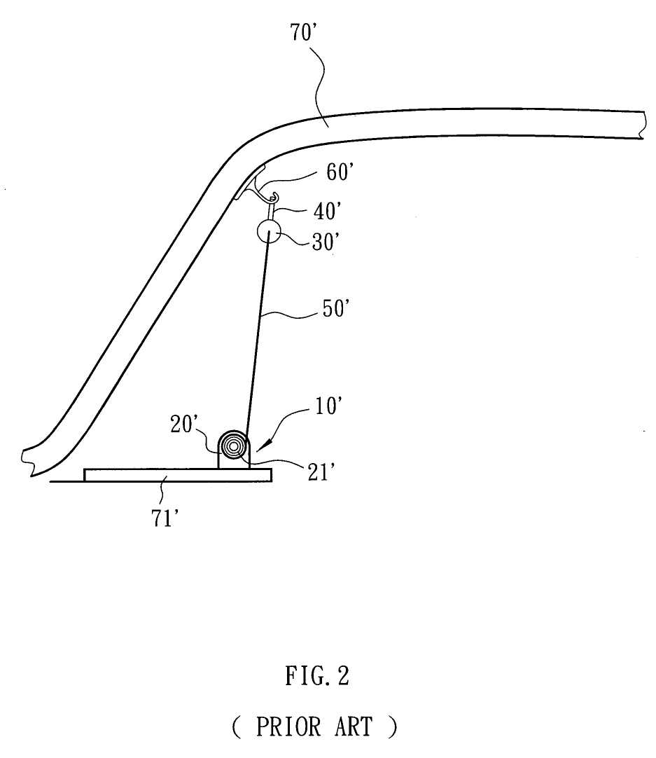

### DETAILED DESCRIPTION OF THE PREFERRED EMBODIMENT

Embodiments of the invention are described in detail below with accompanying drawings.

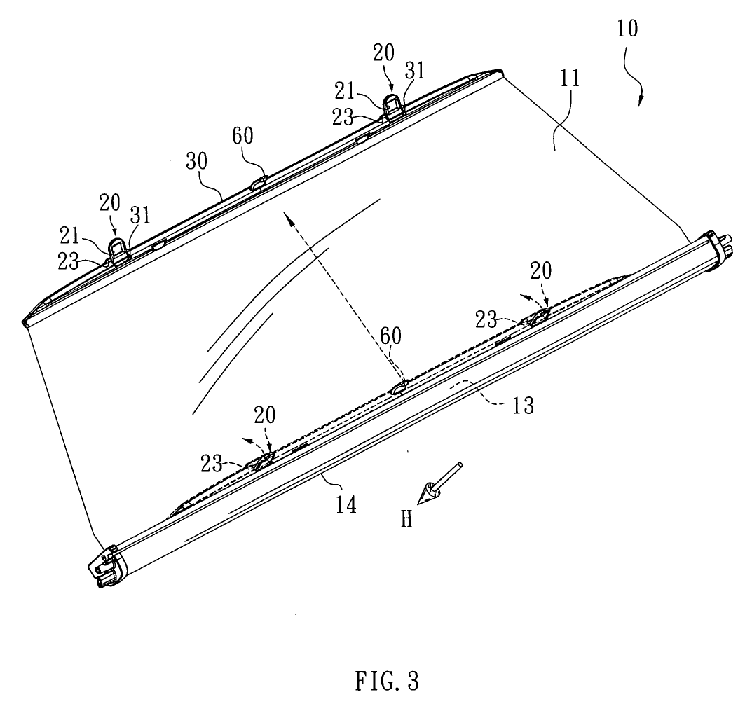

Referring to FIG. 3 which shows the unfolding and folding of a sunshade device in an embodiment of the invention, the mounting of the invention in the direction of head of vehicle H is as shown by the arrow where a sunshade device 10 is mounted at a first position A (to be elaborated later) on a flat board behind the back seat and the curtain 11 in the sunshade device 10 is unfolded and maintained at a second position B (to be elaborated later), for example, onto a hanging bracket 12 (to be elaborated later) installed inside the rear window or the rooftop of vehicle.

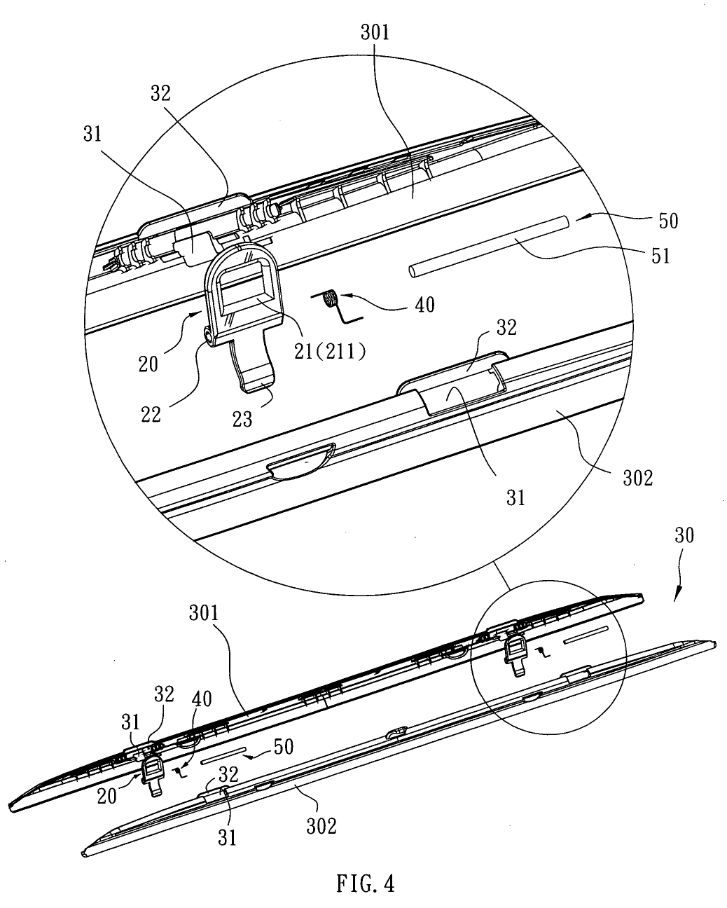

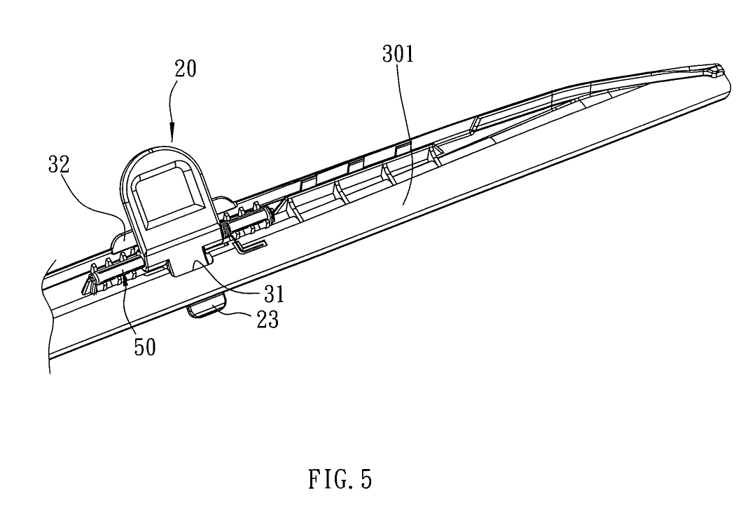

Referring to FIG. 4 and FIG. 5 which show respectively an exploded view and assembly view of the major components of the hanging structure in an embodiment of the invention, the hanging structure comprises at least a hanging unit 20, an edge strip set 30, at least an elastic element 40, and at least a pin-joint element 50. The hanging unit 20 is formed with a hanging member 21 at its head; the edge strip set 30 is connected with one side of curtain 11 and having at least one slot 31 for the placement of hanging unit 20. The edge strip set 30 may be formed in one-piece molding or assembled with a top frame 301 and a bottom frame 302. The elastic element 40 is disposed between the edge strip set 30 and hanging unit 20, and may be a torsion spring with one end attached to or inserted into the hanging unit 20 and the other end pushed against the edge strip set 30. The pin-joint element 50 is used to movably join the hanging unit 20. In the pin-joint structure, an axle hole 22 may be disposed in the hanging unit 20 for the insertion of pin-joint element 50 in the shape of a support shaft 51 thereinto that allows the hanging unit 20 to form variable swing angles in the slot 31 of edge strip set 30.

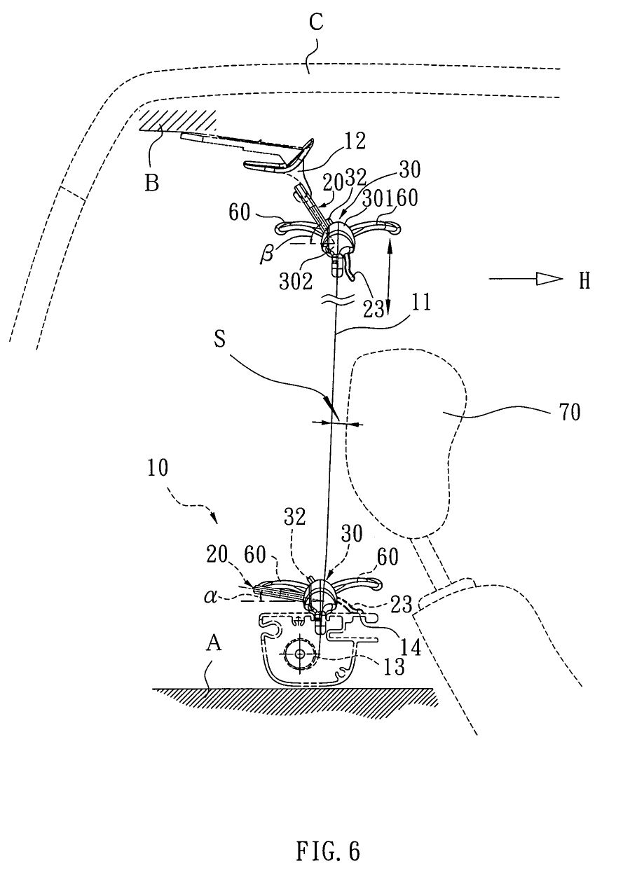

Referring to FIG. 6 which shows an embodiment of the invention in use, the arrow H means the direction of head of vehicle. The invention may be mounted on a flat board behind the backseat of a vehicle C, assuming that at a first position A, and a hanging bracket 12 is installed inside the rear window, the rooftop or the side window, assuming that at a second position B. When the sunshade device 10 is in folded state, the fold/unfold mechanism 13 in the sunshade device 10 would curl up the curtain 11 along with its edge strip set 30. Meanwhile, the tail 23 of hanging unit 20 protruding from the edge strip set 30 would first bump into the external barrel 14 of sunshade device 10 and turn centrically around the axis of pin-joint element 50 in axle hole 22 while laying flat. At this time, the hanging unit 20 forms a first intersection angle α with horizontal line and harbors a restoring torque under the action of elastic element 40. The first intersection angle α is approximately 15° (inclusive) to prevent the over-protrusion of hanging unit 20 from causing obstruction and unsightliness.

When the sunshade device 10 is in unfolded state and the user holds the handle 60 or edge strip set 30 to pull it upward, the external force that is pushed against tail 23 of hanging unit 20 that originally protrudes from the edge strip set 30 disappears, the restoring torque contained therein causes the hanging unit 20 to spring up and turn centrically around the axis of pin-joint element 50 in its axle hole 22 until the hanging unit 20 hits the stopper 32 disposed on one side of slot 31 on edge strip set 30. At this time, the hanging unit 20 forms a second intersection angle β with horizontal line, which should be bigger than the first intersection angle α and preferably ranges between 15° and 90°. The matching of this angle with the angle of hanging bracket 12 at the second position makes the hanging of sunshade device easier and visually more agreeable.

In addition, when the sunshade 10 of the present invention unfolds and is maintained at the second position, preferably there is a space S between its curtain 11 and the headrest 70 of back seat, where S should be at least 1 cm wide to prevent the curtain 11 from rubbing against the headrest 70 of backseat or making noise when blown by the air conditioning system of the vehicle or when the vehicle is bumpy.

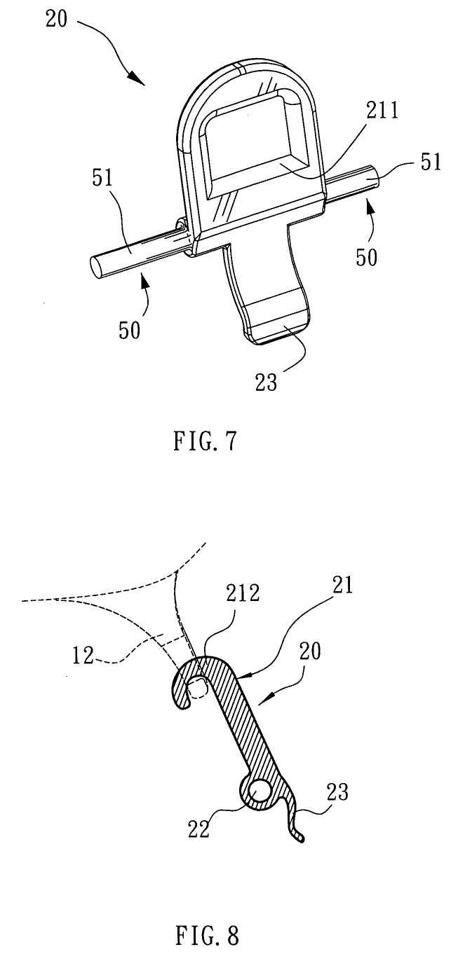

FIG. 7 shows the hanging unit 20 and pin-joint element 50 in another embodiment of the invention where the two components are formed in one-piece molding. During the formation process, the hanging unit 20 is further disposed with a support shaft 51 at its center to allow the hanging unit 20 to form variable swing angles in the slot 31 on edge strip set 30 as illustrated in FIG. 4.

Referring to FIG. 8 showing the hanging member with a hook in an embodiment of the invention, In addition to be designed as the shape of a hole 211, the hanging member 21 of the hanging unit 20 may have the design of a hook 212, which may hook to the hanging bracket 12 by changing the design of the hanging bracket 12 to a hanging hole.

As described above, the hanging structure for sunshade device disclosed in this invention has industrial application, novelty and inventive step, which meet the essential elements of a patent. The description above is merely an embodiment of the invention which should not be construed as a limitation on the scope of claim. All modifications and alterations to the descriptions disclosed shall remain within the protected scope and claims of the invention.

What is claimed is:

1. A hanging structure for sunshade device, applicable to mounting the sunshade device at a first position, and pulling the curtain inside the sunshade device to unfold it and maintain it on at least a hanging bracket at a second position, the hanging structure comprising:
at least a hanging unit having a hanging member at its head; a edge strip set connecting to one end of curtain and having at least one slot;
at least an elastic element disposed between said edge strip set and said hanging unit; and
at least one pin-joint element which movably joins said hanging unit to the slot on said edge strip set and allows said hanging unit to swing inside the slot on said edge strip set; when said sunshade device is at the first position, said hanging unit forms a first intersection angle with horizontal line; when said sunshade device is unfolded from said first position, said hanging unit forms a second intersection angle with horizontal line.

2. The hanging structure according to claim 1, wherein said edge strip set is further disposed with at least a handle for user to unfold or fold the curtain of said sunshade device by hand.

3. The hanging structure according to claim 1, wherein the hanging member of said hanging unit is a hang hole that can engage the hanging bracket at said second position.

4. The hanging structure according to claim 1, wherein the hanging member of said hanging unit is a hook that can engage the hanging hole at said second position.

5. The hanging structure according to claim 2, wherein said edge strip set includes an upper frame and a lower frame.

6. The hanging structure according to claim 1, wherein a stopper is configured on one side of the slot on said edge strip set to block the sprung hanging unit, thereby forming a second intersection angle.

7. The hanging structure according to claim 1, wherein said first intersection angle is smaller than or equal to 15°.

8. The hanging structure according to claim 1, wherein said second intersection angle is bigger than 15° but smaller than or equal to 90°.

9. The hanging structure according to claim 1, wherein said first intersection angle is smaller than said second intersection angle.

10. The hanging structure according to claim 1, wherein said elastic element is a torsion spring.

11. The hanging structure according to claim 1, wherein said hanging unit is further disposed with an axle hole and said pin-joint element is a support shaft.

12. The hanging structure according to claim 1, wherein said pin-joint element is a support shaft and adjoins to said hanging unit in one piece.
